(19) United States
(12) Patent Application Publication
(10) Pub. No.: US 2006/0206663 A1
(43) Pub. Date: Sep. 14, 2006

(54) Disk array device and shared memory device thereof, and control program and control method of disk array device

(75) Inventor: Atsushi Kuwata, Tokyo (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC CORPORATION, Tokyo (JP)

(21) Appl. No.: 11/372,198

(22) Filed: Mar. 10, 2006

(30) Foreign Application Priority Data
Mar. 11, 2005 (JP) 070175/2005

(51) Int. Cl. G06F 12/14; G06F 12/00

(52) U.S. Cl. 711/114; 711/147; 711/130

(57) ABSTRACT

The disk array device realizing speed-up of cache control by the use of a high-speed throughput bus, which includes a director device having an external interface control unit, a data transfer control unit, a control memory, a processor, a command control unit and a communication buffer, and a shared memory device having a cache data storage memory, a command control unit, a communication buffer, a processor and a cache management memory. The director device and the shared memory device are connected through data transfer control units by a data transfer bus and through command control units by a command communication bus. The data transfer bus and the command communication bus are serial buses whose transfer rate is high.

### BACKGROUNDS OF THE INVENTION

1. Field of the Invention

The present invention relates to a disk array device, a cache memory management method, a cache memory management program and a cache memory and, more particularly, a disk array device using a high-speed throughput bus and a shared memory device thereof, a control program and a control method of the disk array device.

2. Description of the Related Art

One example of a conventional disk array device will be described with reference to FIG. 11.

In FIG. 11, the conventional disk array device includes a plurality of director devices 1110 and 1120 having external interfaces 1111 and 1121, data transfer management units 1112 and 1122, processors 1113 and 1123 and management region control units 1114 and 1124, respectively, and a plurality of shared memory devices 1130 and 1140 having cache data storage memories 1131 and 1141 and cache management memories 1132 and 1142, respectively, in which the processors 1113 and 1123 operate management regions of the shared memory devices 1130 and 1140 to execute management and processing of the cache data storage memories 1131 and 1141 and the cache management memories 1132 and 1142.

One example of such a conventional disk array device as described above is recited in, for example, Japanese Patent Laying-Open No. 2004-139260 (Literature 1).

Disclosed in Literature 1 is a structure of a disk device using a system of transferring a command to each microprocessor with respect to command processing from a higher-order host server to dispersedly process the commands by a plurality of microprocessors, thereby mitigating a bottleneck of a microprocessor of an interface unit to prevent degradation of performance of a storage system.

The conventional disk array device as described above, however, has the following problems.

First problem is that because in a conventional disk array device, a processor on a director device controls a cache memory on a shared memory device, memory access should be made through a plurality of layers of buses including a local bus of the director device, a shared bus between the director device and the shared memory device and a memory bus in the shared memory device, resulting in increasing time for memory access.

Second problem is that even with a structure of dispersedly executing processing by a plurality of multiprocessor systems provided with a plurality of director devices shown as conventional art, difficulty in using a processor cache in cache control processing (memory access processing) executed at the processor on the director device makes it difficult to speed up cache memory control processing executed by the processor of the director device.

Third problem is that even when a data transfer capacity is increased by the improvement of basic techniques such as clock-up, with respect to control of a shared cache memory, it is difficult to shorten a processing time by making use of a high-speed throughput bus.

### SUMMARY OF THE INVENTION

An object of the present invention is to solve the above-described problems and provide a disk array device and a shared memory device of the same, a control program and a control method of the disk array device which enable speed-up of cache memory control processing.

As described above, the present invention is characterized in that in place of controlling a cache memory on a shared memory device by means of a processor on a director device, a processor on the shared memory device controls the cache memory on the shared memory device by communication from the processor on the director device.

This arrangement enables the present invention to reduce a processing time required for cache control by making the processor on the shared memory device directly control a memory bus in memory operation. In addition, even when the disk array device is at a state of cache control, the processor on the director device is allowed to use a processor cache. Moreover, even without a plurality of director devices, a processing time required for cache memory control can be reduced by a single director device.

According to the disk array device and the shared memory device of the same, the control program and the control method of the disk array device of the present invention, the following effects can be attained.

First effect is enabling reduction in a processing time required for cache memory control of the shared memory device.

The reason is that the present device is structured such that in place of controlling a cache memory on the shared memory device by means of a processor on a director device, a processor on the shared memory device controls the cache memory on the shared memory device by communication from the processor on the director device.

The second effect is that because the processor on the shared memory device controls the cache memory on the shared memory device to eliminate the need of lock processing for preventing contention of processing among processors of the director devices, a time required for lock processing can be saved.

Other objects, features and advantages of the present invention will become clear from the detailed description given herebelow.

### BRIEF DESCRIPTION OF THE DRAWINGS

The present invention will be understood more fully from the detailed description given herebelow and from the accompanying drawings of the preferred embodiment of the invention, which, however, should not be taken to be limitative to the invention, but are for explanation and understanding only.

In the drawings:

FIG. 1 is a block diagram showing a structure of a disk array device 100 according to a first embodiment of the present invention;

FIG. 2 is a block diagram showing a detailed structure of a processor unit, a communication buffer unit and a command control unit of a shared memory device according to the first embodiment;

FIG. 3 is a flow chart showing read/write operation of the disk array device according to the first embodiment;

FIG. 4 is a diagram showing contents of communication between a director device and the shared memory device in time series according to the first embodiment;

FIG. 5 is a block diagram showing a structure of a disk array device according to a second embodiment;

FIG. 6 is a block diagram showing a structure of a disk array device according to a third embodiment;

FIG. 7 is a block diagram showing a structure of a shared memory device according to a fourth embodiment;

FIG. 8 is a flow chart for use in explaining write back processing of a disk array device according to the fourth embodiment;

FIG. 9 is a block diagram showing a structure of a disk array device according to a fifth embodiment;

FIG. 10 is a block diagram showing a structure of a disk array device according to a sixth embodiment; and

FIG. 11 is a block diagram showing one example of a structure of a conventional disk array device.

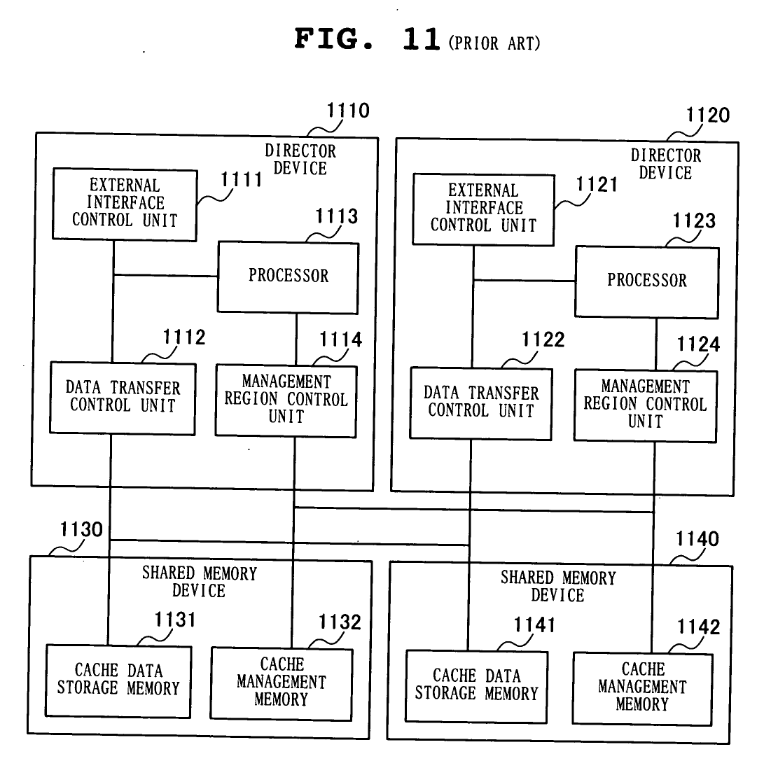

### DESCRIPTION OF THE PREFERRED EMBODIMENT

The preferred embodiment of the present invention will be discussed hereinafter in detail with reference to the accompanying drawings. In the following description, numerous specific details are set forth in order to provide a thorough understanding of the present invention. It will be obvious, however, to those skilled in the art that the present invention may be practiced without these specific details. In other instance, well-known structures are not shown in detail in order to unnecessary obscure the present invention.

### First Embodiment

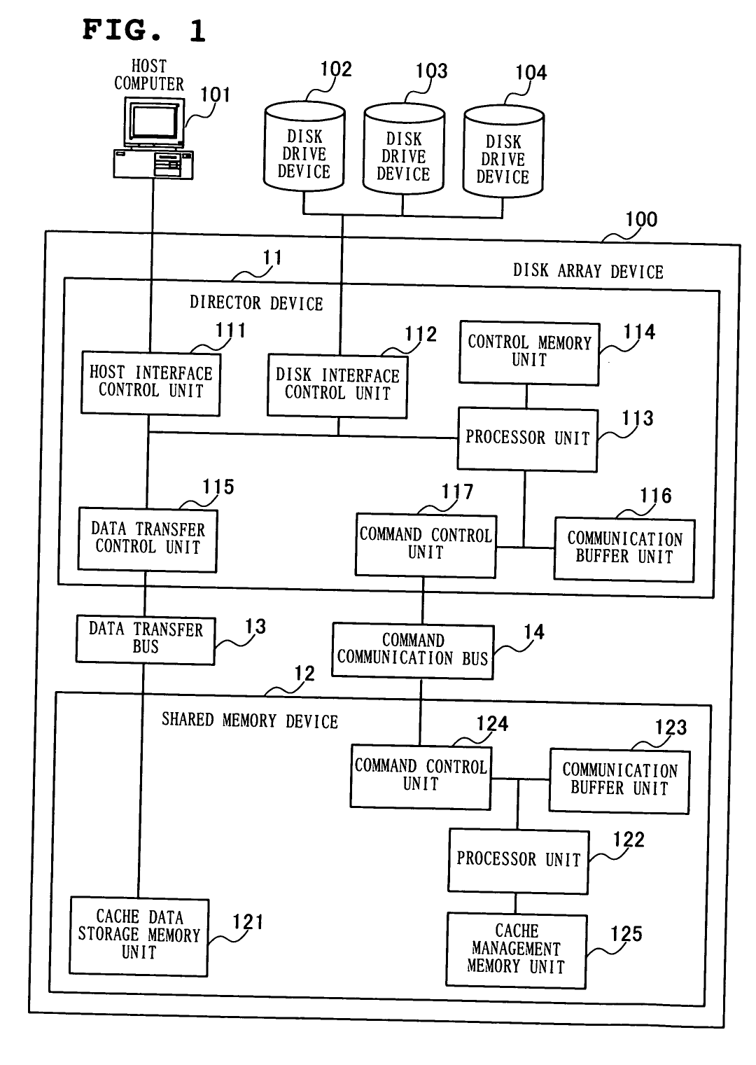

FIG. 1 is a block diagram showing a hardware structure of the disk array device 100 according to the first embodiment of the present invention.

In FIG. 1, the disk array device 100 includes, as its hardware structure, a director device 11 and a shared memory device 12 connected with each other through a data transfer bus 13 and a command communication bus 14.

The director device 11, which is a device that communicates for a command which manages the shared memory device 12 with a host computer 101 and disk drives 102, 103 and 104 to transmit the management command to the shared memory device 12, realizes functions of a host interface control unit 111, a disk interface unit 112, a processor unit 113, a control memory unit 114, a data transfer control unit 115, a communication buffer unit 116 and a command control unit 117 by program control.

The shared memory device 12 realizes the respective functions of a cache data storage memory unit 121, a processor unit 122, a communication buffer unit 123, a command control unit 124 and a cache management memory unit 125 by receiving a command for managing the shared memory device 12 from the director device 11.

The director device 11 and the shared memory device 12 have the data transfer control unit 115 and the cache data storage memory unit 121 connected through the data transfer bus 13 and have the command control units 117 and 124 connected through the command communication bus 14.

The data transfer bus 13 and the command communication bus 14 are serial buses having a high transfer rate, which are buses, for example, Infini Band.

First, a structure of the director device 11 will be described.

The host interface control unit 111 is a device which is connected to the host computer 101, the data transfer control unit 115, the processor unit 113 and the like and has the function of transmitting a command requesting cache data which is received from the host computer 101 to the processor unit 113 according to an instruction from the processor unit 113 and transmitting cache data received from the data transfer control unit 115 to the host computer 101.

The disk interface unit 112, which is connected to the disk drives 102 to 104, the processor unit 113, the data transfer control unit 115 and the like, has the function of transmitting a command requesting cache data to the disk drives 102 to 104 according to an instruction from the processor unit 113 and transmitting cache data received from the disk drives 102 to 104 to the data transfer control unit 115.

The processor unit 113, which is connected to the host interface control unit 111, the disk interface unit 112, the control memory unit 114, the data transfer control unit 115, the communication buffer unit 116 and the command control unit 117, has the function of instructing the disk interface unit 112, the control memory unit 114, the data transfer control unit 115, the communication buffer 116 and the like according to a command received from the host interface control unit 111.

In more detail, the processor unit 113 stores, in the communication buffer unit 116, an instruction for transmitting a command which instructs the shared memory device 12 on cache page open from the command control unit 115 prior to the data transfer.

Here, a cache page represents a region corresponding to cache data stored in the cache data storage memory 121, and memory address information returned by the processor 122 which will be described later is a memory address of a region (cache page) corresponding to the cache data.

The processor 113 further has the function of executing data transfer based on these information returned from the processor 122 and then transmitting a command which instructs on cache page close after the completion of the data transfer. Here, transmitted here are a logical address and cache state information of a cache page to be closed.

Cache state information which will be described later is information indicative of whether valid data is stored in the cache page or not. The cache state information is made valid when data is stored in a free cache page and changed when data yet to be written is newly write down to a disk.

The control memory unit 114 has the function as a processor cache which temporarily stores data to be processed by the processor 113.

The data transfer control unit 115, which is connected to the data transfer bus 13, the host interface control unit 111, the disk interface unit 112 and the processor 113, has the function of transmitting data received from the shared memory device 12 through the data transfer bus 13 to the host interface control unit 111 according to an instruction from the processor unit 113 and transmitting cache data received from the disk interface unit 112 to the shared memory device 12 through the data transfer bus 13.

The communication buffer unit 116, which is connected to the processor unit 113 and the command control unit 117, has the function of storing an instruction from the processor unit 113 and transmitting the instruction to the command control unit 117.

The command control unit 117, which is connected to the command communication bus 14, the processor unit 113 and the communication buffer unit 116, has the function of communicating with the command control unit 124 of the shared memory device 12 through the command communication bus 14 according to an instruction transmitted from the communication buffer unit 116.

More specifically, the command control unit 117 transmits, to the command control unit 124 of the shared memory device 12, a command which instructs the shared memory device 12, on cache page open, to which transmission is instructed by an instruction from the communication buffer unit 116. In addition, as a response to the command, the unit 117 accepts-memory address information, cache state information, a new cache data requesting command and the like received from the command control unit 124 to store the same in the communication buffer unit 116, as well as notifying the processor unit 113 of the same.

Next, a structure of the shared memory device 12 will be described.

The cache data storage memory unit 121, which is connected to the data transfer bus 13, has the function of storing data as a cache memory.

The processor 122, which is connected to the communication buffer unit 123, the command control unit 124 and the cache management memory unit 125, takes in the above command from the communication buffer unit 123 to execute processing related to control of a cache memory such as cache page open control on the cache management memory 125.

In more detail, when an instructed logical address makes a cache hit, the processor 122 returns memory address information and cache state information related to the hit cache page to the processor 113. On the other hand, when a cache miss is obtained, return memory address information and cache state information related to a cache page newly assigned by purging control to the processor 113.

The communication buffer unit 123 is a device which is connected to the command control unit 124 and the processor 122 and has the function of transmitting and receiving data to/from the command control unit 124 and the processor 122 to store received data.

The command control unit 124 is a device which is connected to the command communication bus 14, the processor unit 122 and the communication buffer unit 123 and stores a command received from the command control unit 117 through the command communication bus 14 in the communication buffer unit 123 and notifies the processor 122 by an interruption signal.

The cache management memory unit 125 manages an assignment state of a cache data storage memory.

Among characteristics of the structure of the disk array device 100 according to the first embodiment of the present invention is having the processor 122 and the command control unit 124 in the shared memory device. Another characteristic is having the communication buffer unit 123 which mediates communication between the processor 122 and the command control unit 124.

A further characteristic is having the host interface unit 111 and the disk interface unit 112 in the director device 11.

A still further characteristic is transmitting and receiving cache state information in addition to memory address information between the processors 114 and 122.

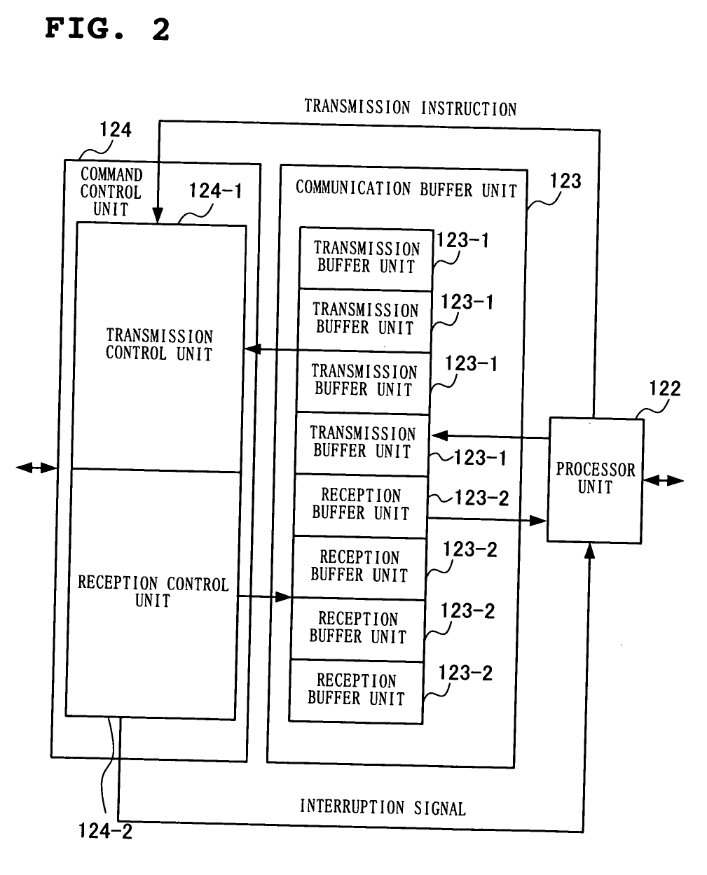

With reference to FIG. 2, shown is a detailed structure of the processor unit, the communication buffer unit and the command control unit of the shared memory device illustrated in FIG. 1.

As shown in FIG. 2, the communication buffer unit 123 is a device which executes data communication with the processor unit 122 and the command control unit 124.

In the present embodiment, the communication buffer unit 123 is formed of a plurality of transmission buffer units 123-1 and reception buffer units 123-2, and the command control unit 124 is formed of a transmission control unit 124-1 and a reception control unit 124-2.

In FIG. 2, the transmission buffer unit 123-1 and the reception buffer unit 123-2 forming the communication buffer unit 123 each have an FIFO (First In First Out) structure.

When the processor unit 122 writes information to the transmission buffer 123-1 and issues a transmission instruction to the transmission control unit 124-1, the transmission control unit 124-1 transmits data through a serial bus.

Upon receiving the data through the serial bus, the reception control unit 124-2 writes the received data to the reception buffer 123-2 to notify the processor unit 122 by an interruption signal.

While the structure of the present embodiment has been described in detail in the foregoing, since the serial bus and the buffer having an FIFO structure shown in FIG. 2 are well known to those skilled in the art and is not directly relevant to the present invention, description of their detailed structures will be omitted.

As a specific example of the present embodiment, a part of a local memory of the processor unit can be used as the communication buffer unit. In this case, a processor cache may be used in accessing the communication buffer unit.

While the present embodiment has been described with respect to an example of the shared memory device 12, the same description is also applicable to the case of the director device 11.

Next, description will be made of read/write operation of the disk array device according to the present embodiment.

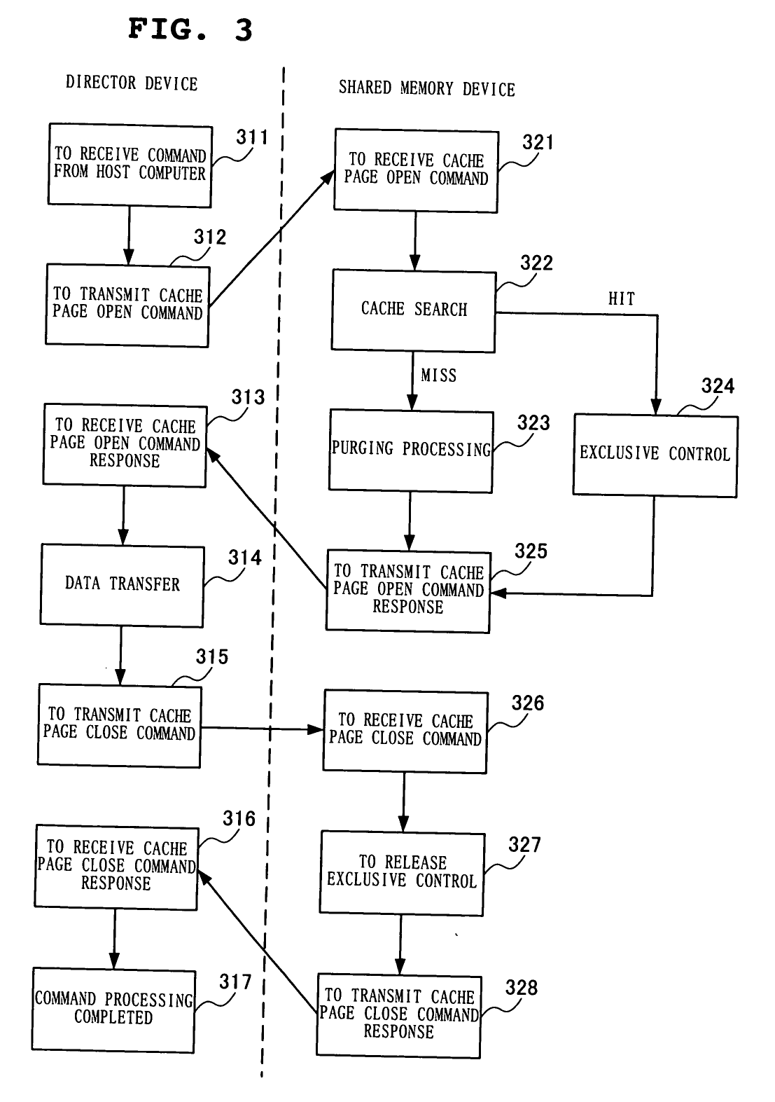

FIG. 3 is a flow chart showing operation of the host director device 11 and the shared memory device 12 in read/write operation of the disk array device 100 according to the first embodiment.

As shown in FIG. 3, upon receiving a command instructing on cache page open from the host computer 101 at Step 311, the director device 11 stores the cache page open command in the communication buffer unit 116 and the command control unit 117 transmits the command to the shared memory device 12 at Step 312. Thereafter, while the processor unit 113 waits for a response to the communication, it is allowed to execute another command processing.

Upon receiving the cache page open command from the director device 11 at Step 321, the shared memory device 12 executes cache page search processing on the cache management memory unit 125 at Step 322.

Next, when the cache page search processing results in a cache miss, execute processing of newly assigning a cache page by purging processing at Step 323.

Subsequently, when the cache page search processing results in a cache hit, if the cache page is open, wait for the page to be released at Step 324. Meanwhile, the processor unit 122 is allowed to execute another cache processing.

When a cache region to be used is defined by the foregoing processing at Step 323 or Step 324, the shared memory device 12 transmits a memory address and cache state information to the director device 11 as a response to the cache page open command at Step 325.

The processor unit 113 of the director device 11 confirms completion of the cache page open processing by the reception of an interruption signal from the command control unit 117 at Step 313.

Next, the processor unit 113 refers to the sent cache state information to execute necessary data transfer at Step 314. Necessary data transfer, in a case of read processing, is data transfer from the shared memory device 12 to the host computer 101 when in cache hit and data transfer from the disk drives 102 through 104 to the shared memory device 12 and data transfer from the shared memory device 12 to the host computer 101 when in cache miss. On the other hand, in a case of write processing, execute data transfer from the host computer 101 to the shared memory device 12. In addition, execute data transfer from the shared memory device 12 to the disk drives 102 through 104 when required.

When the data transfer is completed, the processor unit 113 generates a cache page close command and the command control unit 117 transmits the command to the shared memory device 12 at Step 315 similarly to Step 312.

When receiving the cache page close command at Step 326 similarly to Step 321, the processor unit 122 releases exclusive control at Step 327. Here, when processing of waiting for use of the same cache page exists, the processing is brought to be available.

Next, the share memory device 12 transmits a response to the cache page close command to the director device 11 at Step 328 similarly to Step 325.

Upon receiving the response from the processor 122 at Step 316 similarly to Step 313, the director device 11 completes the processing of the command received from the host computer 101 at Step 317.

Since in the present embodiment, cache control on the shared memory device 12 is executed by the single processor 122 on the shared memory device 12 to which a command is transmitted from the processor 113 of the director device 11 in place of execution by the processor 113 of the director device 11, the processor 122 of the shared memory device 12 directly controls a memory bus in memory operation and the processor 116 of the director device 11 is allowed to use a processor cache, so that a processing time required for cache control can be reduced.

Write back processing by the director device 11 may be executed synchronously with processing of writing data to the cache data storage memory 121 or may be executed asynchronously.

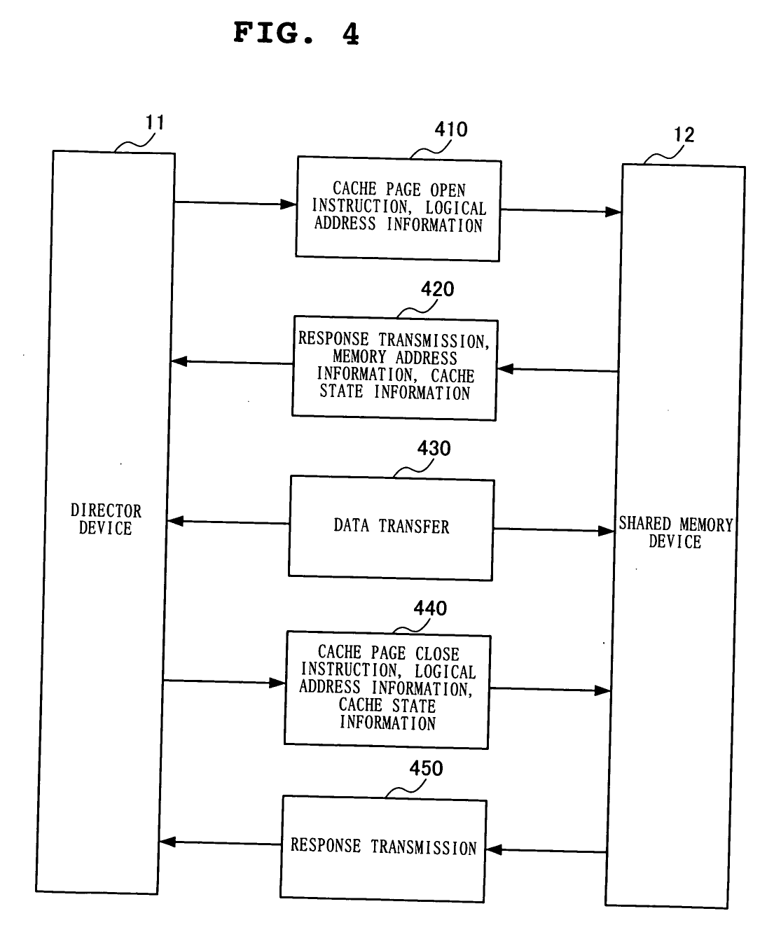

FIG. 4 is a diagram showing the contents of communication between the director device and the shared memory device in time series with respect to processing of the disk array device according to the present embodiment.

With reference to FIG. 4, in the communication in the present embodiment, first, the director device 11 instructs the shared memory device 12 on cache page open at Step 410. Here, attach logical address information of a command requested from the host computer 101 to the communication.

Next, at Step 420, the shared memory device 12 transmits, to the director device 11, memory address information and cache state information of a cache page assigned to the director device 11 as a response to Step 410.

Next, at Step 430, with the opened cache page of the shared memory device 12, the director device 11 executes data transfer between the host computer 101 and the shared memory device 12 and data transfer between the disks 102 through 104 and the shared memory device 12 (discrimination between a cache hit and a cache miss by cache search is required?).

Upon completion of the data transfer, the director device 11 instructs the shared memory device 12 on cache page close at Step 440. Here, attach a logical address and cache state information to the communication.

Lastly, at Step 450, the shared memory device 12 notifies the director device 11 of the completion of the processing as a response to Step 440 to end the processing of the disk array device 100.

(Effects of the First Embodiment)

According to the first embodiment, since cache control on the shared memory device 12 is executed by the processor 122 on the shared memory device 12 based on communication from the processor 113 on the director device 11 in place of execution by the processor 113 on the director device 11, the processor 122 on the shared memory device 12 directly controls a memory bus in memory operation and the processor 113 on the director device 11 is allowed to use a processor cache, so that a processing time required for cache memory control can be reduced.

Moreover, since communication processing between the director device and the shared memory device for cache control is executed only by instructing the control unit not by direct execution by the processor, overhead caused by communication can be reduced to realize speed-up of the processing.

In addition, use of a serial bus whose transfer rate is high as the command communication bus 14 enables a plurality of pieces of information including a memory address and cache state information to be mounted on transfer information, thereby achieving reduction in a transfer time.

### Second Embodiment

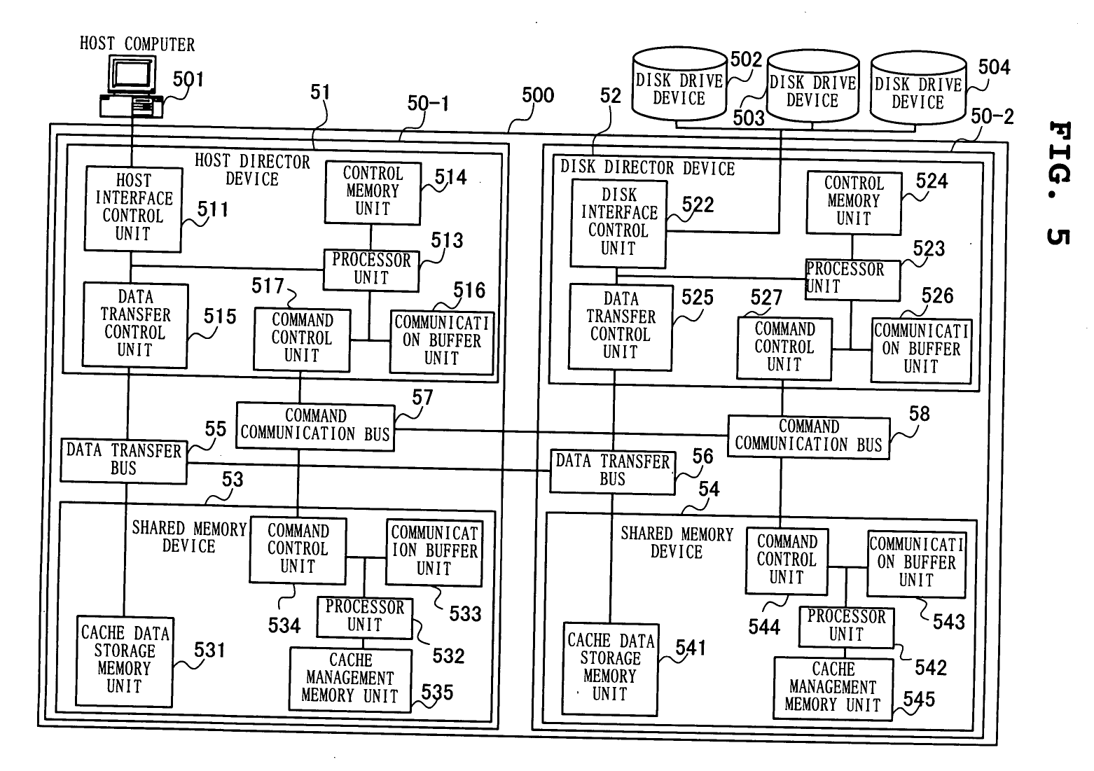

FIG. 5 is a block diagram showing a hardware structure of a disk array device according to a second embodiment of the present invention.

With reference to FIG. 5, a disk array device 500 according to the second embodiment of the present invention is illustrated. In the following, a structure of the disk array device 500 according to the present embodiment will be described while appropriately omitting description overlapping with that of the first embodiment.

As illustrated in FIG. 5, the disk array device 500 of the second embodiment includes disk array units 50-1 and 50-2 to which data transfer buses 55 and 56 and command communication buses 57 and 58 are connected, respectively.

In the disk array device 500 of the present embodiment, similarly to the disk array device 100 according to the first embodiment, the disk array unit 50-1 has a host director device 51 and a shared memory device 53 and the disk array unit 50-2 has a disk director device 52 and a shared memory device 54.

The disk array device 500 according to the present embodiment differs from the disk array device 100 according to the first embodiment in including a plurality of disk array units such as the disk array units 50-1 and 50-2 and in that the host director device 51 fails to have a disk interface unit, that the disk director device 52 fails to have a host interface unit, that the data transfer buses 55 and 56 are connected with each other and that the command communication buses 57 and 58 are connected with each other.

In FIG. 5, a processor 513 of the host director device 51 transmits, to the shared memory devices 53 and 54, a command created on a communication buffer unit 516 by discriminating a command received from a host computer 501.

The disk director device 52, which is connected to disk drives 502, 503 and 504 through a disk interface control unit 522, communicates with the shared memory devices 53 and 54 upon an instruction from the host director device 51.

The host director device 51, the disk director device 52 and the shared memory devices 53 and 54 include processor units (513, 523, 532 and 542), communication buffer units (516, 526, 533 and 543) and command control units (517, 527, 534 and 544), respectively.

Data transfer control units 515 and 525 which the host director device 51 and the disk director device 52 have, respectively, are connected to cache data storage memories 531 and 541 by the data transfer buses 55 and 56 formed by a high-speed transfer bus such as a serial bus.

All the command control units (517, 527, 534 and 544) are connected with each other by the command communication buses 57 and 58 formed of a high-speed transfer bus such as a serial bus.

Read/write operation at the disk array device according to the present embodiment will be described.

Since the read/write operation of the disk array device according to the present embodiment is the same as the read/write operation of the disk array device according to the first embodiment, description will be made with reference to FIG. 2 while appropriately omitting an overlapping part.

The read/write operation according to the present embodiment differs from the read/write operation according to the first embodiment in that the plurality of shared memory devices 53 and 54 communicate with the host director device 51, that data transfer is made as required from the plurality of the shared memory devices 53 and 54 to the disk drives 502 to 504 and that at that time, communication is executed as required between the host director device 51 and the disk director device 52.

In the present embodiment, in particular, the processor unit 513 of the host director device 51 refers to sent cache state information at Step 213 and executes necessary data transfer with the shared memory devices 53 and 54 at Step 214. Necessary data transfer, in a case of read processing, is data transfer from the shared memory devices 53 and 54 to the host computer 501 when in cache hit and data transfer from the disk drives 502 through 504 to the shared memory devices 53 and 54 and data transfer from the shared memory devices 53 and 54 to the host computer 501 when in cache miss. On the other hand, in a case of write processing, execute data transfer from the host computer 501 to the shared memory devices 53 and 54 and if necessary, data transfer from the shared memory devices 53 and 54 to the disk drives 502 through 504.

At this time, communication is executed as required between the host director device 51 and the disk director device 52.

(Effects of the Second Embodiment)

According to the second embodiment, since cache control on the shared memory devices 53 and 54 is executed by the single processor units 532 and 542 on the shared memory devices 53 and 54 based on communication from each processor unit on the plurality of the director devices 51 and 52 in place of execution by the respective processor units 513 and 523 on the plurality of the director devices 51 and 52, the processor units 532 and 542 of the shared memory devices 53 and 54 directly control a memory bus in memory operation and the respective processors 513 and 523 of the plurality of the director devices 51 and 52 are allowed to use a processor cache, so that a processing time required for cache control can be reduced.

Moreover, since the cache memory on the shared memory device is controlled by the processor on the shared memory devices 53 and 54, the need of lock processing for preventing contention of processing among the processors of the director devices is eliminated, so that a time required for lock processing will be saved to speed up the processing.

### Third Embodiment

While a third embodiment of the present invention has its basic structure be the same as that of the above-described second embodiment, it has further arrangement for eliminating the need of communication between a host director device and a disk director device.

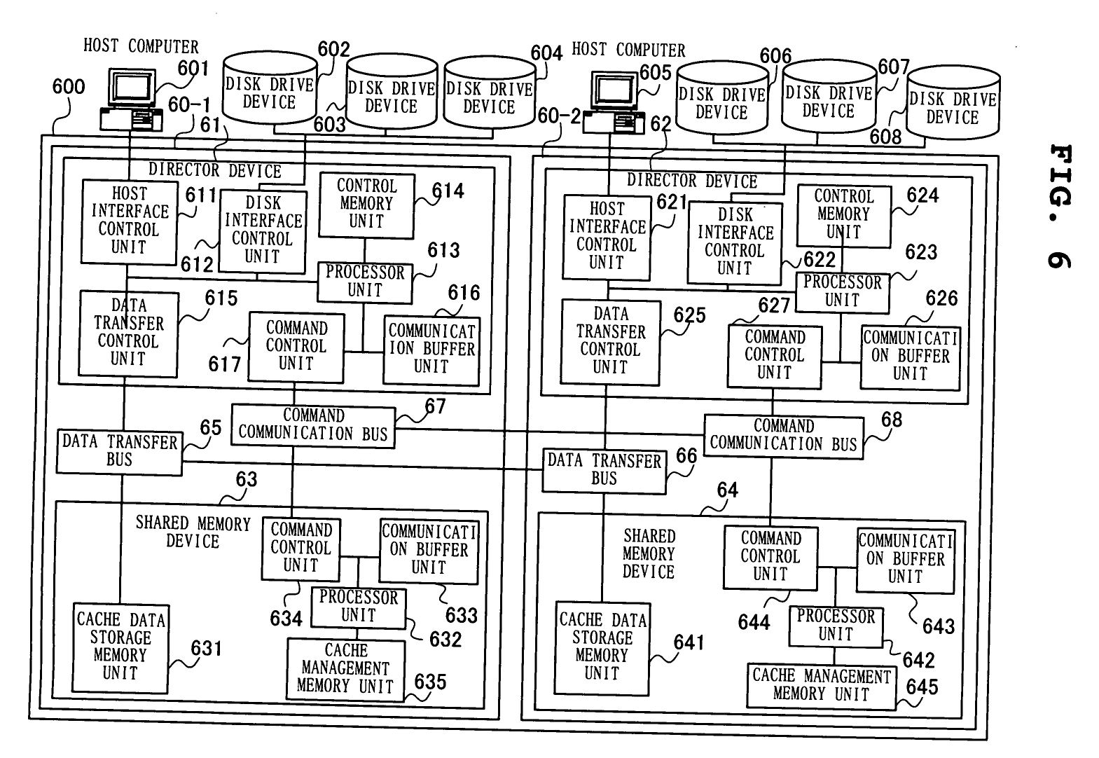

FIG. 6 is a block diagram showing a structure of a disk array device 600 according to the third embodiment of the present invention.

With reference to FIG. 6, disk array units 60-1 and 60-2 according to the present embodiment have the same structure as those in the disk array device 100 (see FIG. 1) according to the first embodiment.

Therefore, according to the present embodiment, since processor units 632 and 642 on shared memory devices 63 and 64 execute cache management control by communication from processor units 613 and 623 on a plurality of director devices 61 and 62, the processor units 632 and 642 of the shared memory devices 63 and 64 directly control a memory bus in memory operation and the processor units 613 and 623 of the director devices 61 and 62 are allowed to use a processor cache, so that even with a plurality of director devices, a processing time required for cache control can be reduced.

In addition, unlike the host director device 31 (see FIG. 3) according to the second embodiment, the director device 61 according to the present embodiment includes a host interface control unit 611 and a disk interface control unit 612 and also the director device 62, unlike the disk director device 32 (see FIG. 3) according to the second embodiment and similarly to the director device 61, includes a host interface control unit 621 and a disk interface control unit 622.

(Effects of the Third Embodiment)

Since according to the third embodiment, similarly to the director device 11 according to the first embodiment, the director devices 61 and 62 include the host interface control units 611 and 621 and the disk interface control units 612 and 622, respectively, as compared with the effects attained by the second embodiment, at the time of data transfer after receiving a memory address from the shared memory devices 63 and 64, command processing can be all completed by the respective director devices without communication between the director devices 61 and 62.

### Fourth Embodiment

While a fourth embodiment of the present invention has its basic structure be the same as that of the above-described third embodiment, it has further arrangement for parity operation processing in write back processing of data from a shared memory device to a disk drive.

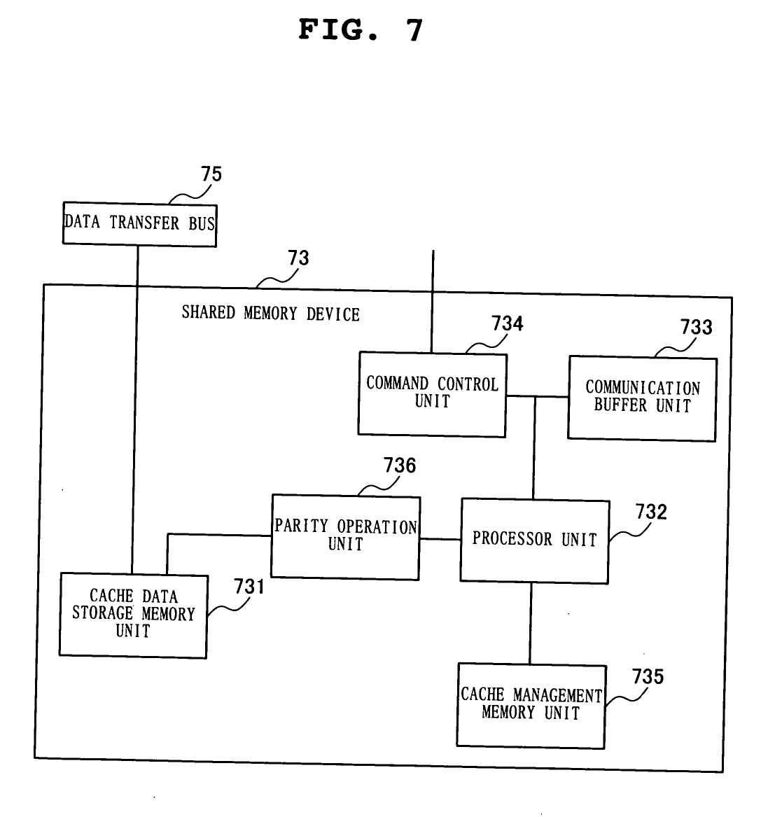

FIG. 7 is a block diagram showing a structure of a shared memory device having a parity operation processing function according to the fourth embodiment of the present invention.

With reference to FIG. 7, while a shared memory device 73 has the same structure as that of the shared memory devices 63 and 64 illustrated in FIG. 6 according to the third embodiment, as compared with the structure of the shared memory devices 63 and 64, it has a parity operation unit 736 to enable parity operation required for RAID control to be executed at a closed state within the shared memory device 73.

Accordingly, load on parity operation processing by the director device can be mitigated.

The parity operation unit 736 is structured to be connected to a cache data storage memory unit 731 and a processor unit 732 to transmit data to the cache data storage memory unit 731 in response to an instruction from the processor unit 732 by other path than a data transfer bus 75 by which the cache data storage memory unit 731 transmits and receives data to/from director devices 71 and 72.

Accordingly, contention of the data transfer bus 75 is mitigated to realize improvement in transfer rate.

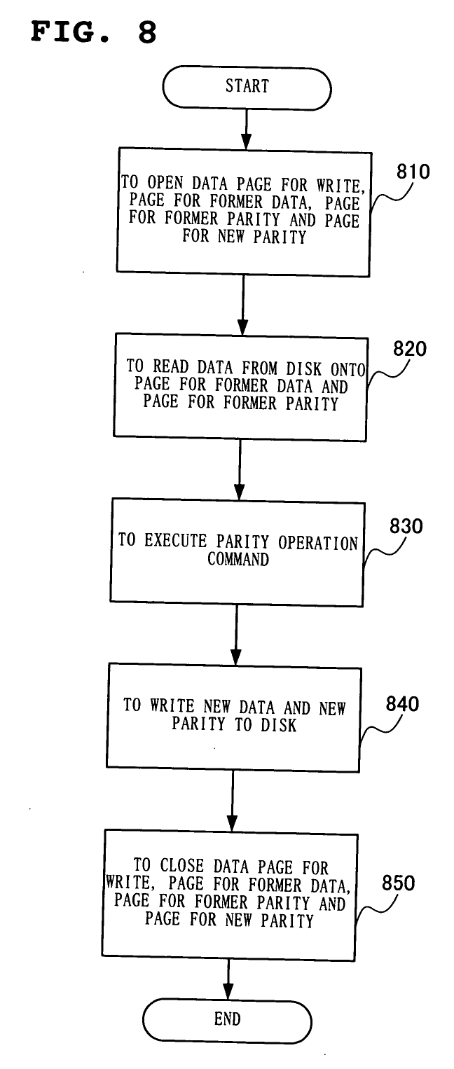

FIG. 8 is a flow chart for use in explaining write back processing of the disk array device according to the fourth embodiment.

With reference to FIG. 8, in the write back processing according to the fourth embodiment, first open a data page for write, a page for former data, a page for former parity and a page for new parity at Step 810.

Next, at Step 820, read data from a disk drive onto the page for former data and the page for former parity.

Next, at Step 830, communicate a command instructing on parity operation from the director device to the shared memory device 73. Upon receiving the command, the processor 732 instructs the parity operation unit 736 on parity operation to execute parity operation.

Next, at Step 840, write new data and a new parity to the disk.

Lastly, at Step 850, close the data page for write, the page for former data, the page for former parity and the page for new parity.

(Effects of the Fourth Embodiment)

According to the fourth embodiment, since data related to parity operation processing is processed only within the shared memory device 73, a transfer time of data related to the parity operation processing is reduced to obtain the effect of improving performance of the device as a whole.

In addition, since the parity operation processing is executed by the processor 732 of the shared memory device 73 in place of the processor of the director device, load on parity operation processing by the director device can be mitigated to have the effect of reducing overhead caused by communication.

In the present embodiment, the parity operation unit 736 may use a data copy function in the shared memory device 73 or the like, or the processor unit 732 may have the same function.

### Fifth Embodiment

While a fifth embodiment of the present invention has its basic structure be the same as that of the above-described second embodiment, it is structured to have an additional disk director device and have one shared memory device.

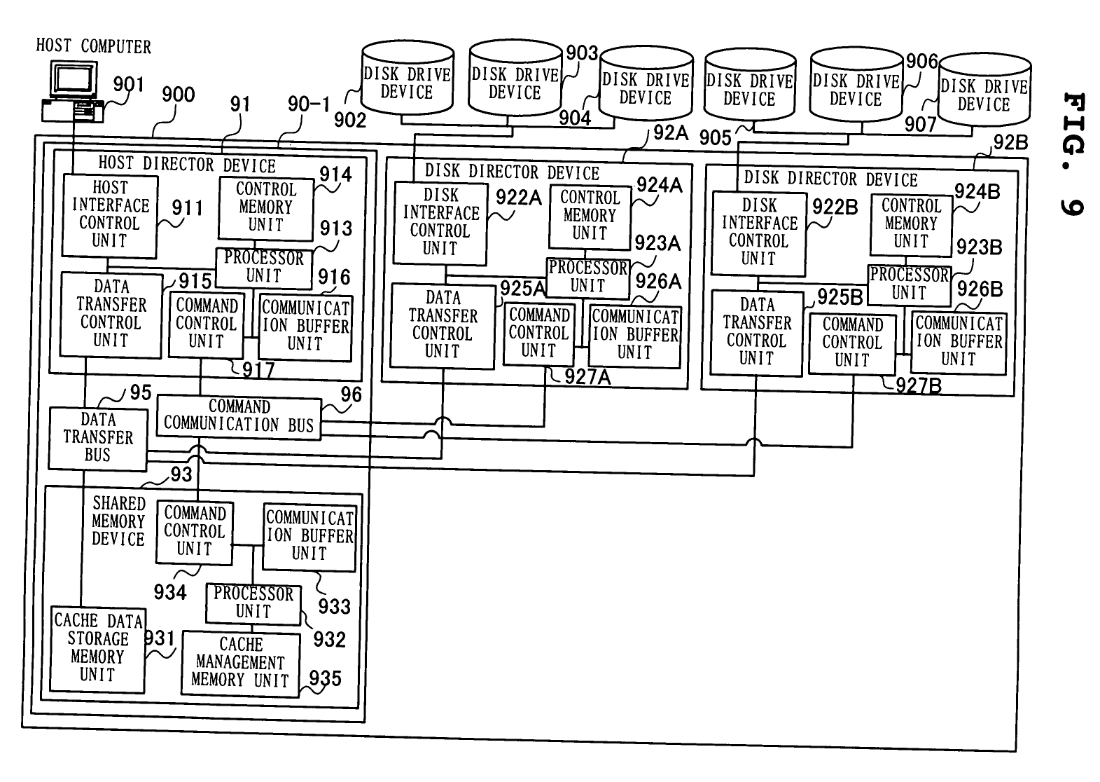

FIG. 9 is a block diagram showing a structure of a disk array device 900 according to the fifth embodiment of the present invention.

With reference to FIG. 9, the disk array device 900 includes one host director device 91, a plurality of disk director devices 92A and 92B and one shared memory device 93.

(Effect of the Fifth Embodiment)

Similarly to the second embodiment, since according to the fifth embodiment, cache control on the shared memory device 93 is executed by a single processor unit 932 on the shared memory device 93 in place of processor units 913, 923A and 923B on the plurality of the director devices 91, 92A and 92B, the processor unit 932 directly controls a memory bus in memory operation and the respective processors 913, 923A and 923B are allowed to use a processor cache, so that a processing time required for cache control can be reduced.

### Sixth Embodiment

While the sixth embodiment of the present invention has its basic structure be the same as that of the above-described third embodiment, it is structured to have an additional shared memory device and one director device.

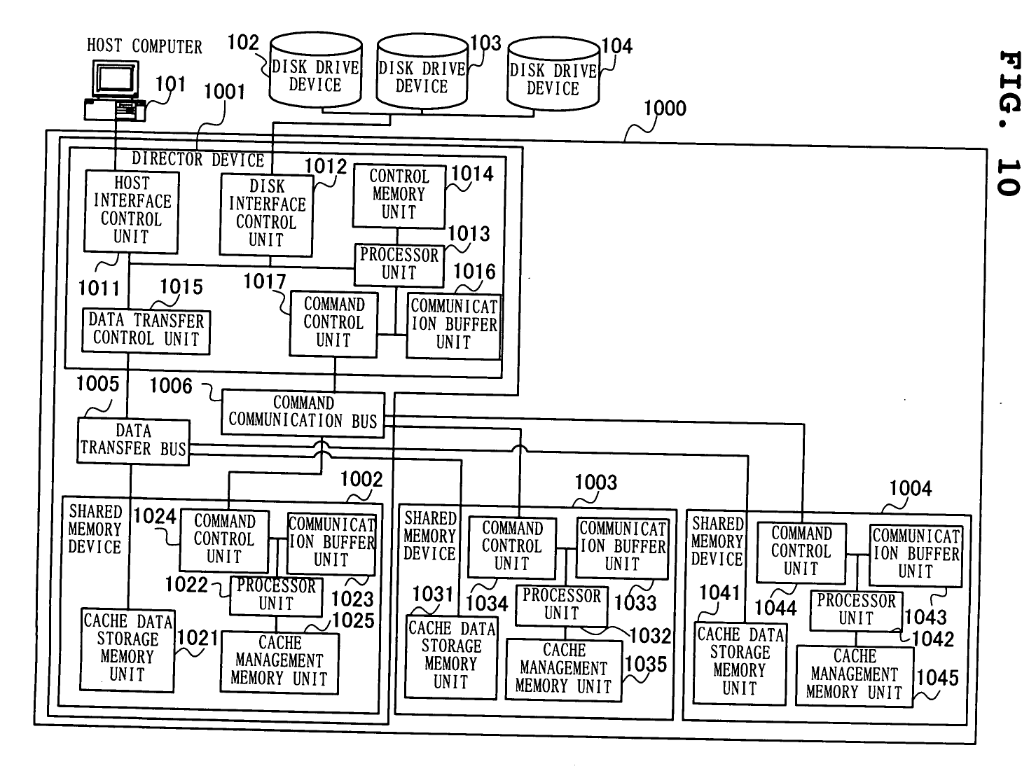

FIG. 10 is a block diagram showing a structure of a disk array device 1000 according to the sixth embodiment of the present invention.

With reference to FIG. 10, the disk array device 1000 includes one director device and a plurality of shared memory devices.

(Effect of the Sixth Embodiment)

Since according to the sixth embodiment, similarly to the third embodiment, cache control on a plurality of shared memory devices 1003 and 1004 is executed by single processor units 1032 and 1042 on the shared memory devices 1003 and 1004 in place of a processor unit 1013 on a director device 1001, the processor units 1032 and 1042 directly control a memory bus in memory operation and the processor unit 1013 is allowed to use a processor cache, so that a processing time required for cache control can be reduced.

While the present invention has been described with respect to the preferred embodiments in the foregoing, the present invention is not necessarily limited to the above-described embodiments and can be embodied in various forms within the scope of its technical idea.

### APPLICABILITY IN THE INDUSTRY

Data required for information processing systems has been increasing in capacity year by year and more and more external storage devices have been connected to a wide range of systems from a personal computer to a large-sized computer. In particular, there is a case where an SAN is established for preventing useless capacity caused by having an individual storage by sharing a storage by a plurality of information processing systems. Introduced in this case is a system which combines numbers of switch devices and small-scale storage devices, or a large storage for realizing a high level solution such as a backup solution.

The present invention is applicable for providing a single large-scale storage device mounted with numbers of host connection ports, numbers of disk drives and a cache memory of a large capacity with improved performance.

Although the invention has been illustrated and described with respect to exemplary embodiment thereof, it should be understood by those skilled in the art that the foregoing and various other changes, omissions and additions may be made therein and thereto, without departing from the spirit and scope of the present invention. Therefore, the present invention should not be understood as limited to the specific embodiment set out above but to include all possible embodiments which can be embodies within a scope encompassed and equivalents thereof with respect to the feature set out in the appended claims.

What is claimed is:

1. A disk array device including a director device which manages input/output of data to/from an external device and a disk drive device, and a shared memory device having a cache memory for input/output data, wherein
said director device transmits a command for instructing on control of the cache memory for said input/output data to said shared memory device, and
said shared memory device executes control of said cache memory for said input/output data based on a command from said director device.

2. The disk array device as set forth in claim 1, wherein
said director device includes
a command control unit which transmits said command and receives a processing result for said command which is sent from said shared memory device, and
said shared memory device includes
a processing unit which executes control of said cache memory for said input/output data based on a command from said director device, and
a command control unit which receives a command from said director device and transmits a processing result for said command from said shared memory device.

3. The disk array device as set forth in claim 2, wherein
the command control units of said director device and said shared memory device are connected with each other by a communication bus whose transfer rate is high, and
the command control units of said director device and said shared memory device transmit and receive information related to a state of said cache memory.

4. The disk array device as set forth in claim 1, wherein
said director device includes a communication buffer unit, and
said director device is released from control operation for said shared memory device upon storage of said command in said communication buffer.

5. The disk array device as set forth in claim 4, wherein
said director device receives a processing result for said command which is sent from said shared memory device at said communication buffer.

6. The disk array device as set forth in claim 1, wherein
said shared memory device includes a communication buffer unit which receives and stores said command sent from said director device and stores a processing result for said command.

7. The disk array device as set forth in claim 2, comprising:
said director device and said shared memory device in plural, wherein
the plurality of said director devices and the plurality of said shared memory devices are connected with each other through said command control units.

8. The disk array device as set forth in claim 7, wherein
said director device includes a communication buffer, said communication buffer receiving a plurality of processing results for said commands which are sent from the plurality of said memory devices in the lump.

9. The disk array device as set forth in claim 7, wherein
the plurality of said shared memory devices each include a communication buffer unit which receives said commands sent from the plurality of said director devices in the lump and stores a processing result for said commands.

10. The disk array device as set forth in claim 7, wherein
the plurality of said director devices are separately formed as a host director device which accepts a data request from said external device and other director device to which said disk drive device is connected.

11. The disk array device as set forth in claim 7, wherein
the plurality of said director devices are each formed to be connected to said external device and said disk drive device.

12. The disk array device as set forth in claim 1, comprising:
said director device in plural and single said shared memory device, wherein
the plurality of said director devices transmit, to a processing unit of said shared memory device, a command instructing on control of the cache memory.

13. The disk array device as set forth in claim 1, comprising:
single said director device and said shared memory devices in plural, wherein
said director device transmits, to the plurality of said shared memory devices, a command instructing on control of the cache memory.

14. The disk array device as set forth in claim 1, wherein
said shared memory device is provided with a parity operation unit which executes parity operation processing for data of said cache memory in processing of write back to said disk drive device.

15. The disk array device as set forth in claim 14, wherein
said parity operation unit is connected to said cache memory by other path than a data transfer path of said cache memory.

16. The disk array device as set forth in claim 1, wherein
said director device and said shared memory device are separately formed to be individual devices.

17. A shared memory device of a disk array device including a director device which manages input/output of data to/from an external device and a disk drive device, and a shared memory device having a cache memory for input/output data, wherein
based on a command for instructing on control of the cache memory for said input/output data which is transmitted from said director device, control of said cache memory for said input/output data is executed.

18. The shared memory device of the disk array device as set forth in claim 17, comprising:
a processing unit which executes control of said cache memory for said input/output data based on a command from said director device, and
a command control unit which receives said command transmitted from a command control unit of said director device and transmits a processing result for said command to the command control unit of said director device.

19. The shared memory device of the disk array device as set forth in claim 18, which
is connected through said command control unit to the command control unit of said director device with each other by a communication bus, and
transmits and receives information related to a state of said cache memory to/from the command control unit of said director device.

20. The shared memory device of the disk array device as set forth in claim 17, comprising:
a communication buffer unit which receives and stores said command sent from said director device and stores a processing result for said command.

21. The shared memory device of the disk array device as set forth in claim 18, comprising:
said director device and said shared memory device in plural, wherein the plurality of said director devices and the plurality of said shared memory devices are connected with each other through said command control units.

22. The shared memory device of the disk array device as set forth in claim 21, wherein
the plurality of said shared memory devices each include a communication buffer unit which receives said commands sent from the plurality of said director devices in the lump and stores a processing result for said commands.

23. The shared memory device of the disk array device as set forth in claim 17, wherein
said shared memory device is provided with a parity operation unit which executes parity operation processing for data of said cache memory in processing of write back to said disk drive device.

24. The shared memory device of the disk array device as set forth in claim 23, wherein
said parity operation unit is connected to said cache memory by other path than a data transfer path of said cache memory.

25. The shared memory device of the disk array device as set forth in claim 17, which is formed as an individual device separately from said director device.

26. A control program for controlling input/output of data in a disk array device including a director device which manages input/output of data to/from an external device and a disk drive device, and a shared memory device having a cache memory for said input/output data,
said control program being executed on a processor of said director device and a processor provided in said shared memory device and having the functions of:
transmitting, to the processor of said director device, a command for instructing said shared memory device to control the cache memory for said input/output data, and
causing the processor of said shared memory device to execute control of said cache memory for said input/output data based on a command from said director device.

27. The control program of the disk array device as set forth in claim 26, which realizes:
in the processor of said director device, the function of transmitting said command and receiving a processing result for said command which is sent from said shared memory device, and
in the processor of said shared memory device,
the function of executing control of said cache memory for said input/output data based on a command from said director device, and
the function of receiving a command from said director device and transmitting a processing result for said command from said shared memory device.

28. The control program of the disk array device as set forth in claim 27, which realizes
for the processor of said director device and the processor of said shared memory device, the function of transmitting and receiving information related to a state of said cache memory between said director device and said shared memory device.

29. A control method of controlling input/output of data in a disk array device including a director device which manages input/output of data to/from an external device and a disk drive device, and a shared memory device having a cache memory for said input/output data, comprising:
the step of transmitting, from a processor of said director device, a command for instructing a processor of said shared memory device to control the cache memory for said input/output data, and
the step of the processor of said shared memory device to execute control of said cache memory for said input/output data based on a command from said director device.

30. The control method of the disk array device as set forth in claim 29, wherein
the processor of said director device includes the step of:
transmitting said command and receiving a processing result for said command which is sent from said shared memory device, and
the processor of said shared memory device includes the steps of:
executing control of said cache memory for said input/output data based on a command from said director device, and
receiving a command from said director device and transmitting a processing result for said command from said shared memory device.

31. The control method of the disk array device as set forth in claim 30, comprising the step of:
transmitting and receiving information related to a state of said cache memory between the processor of said director device and the processor of said shared memory device.
